(19) United States
(12) Patent Application Publication
(10) Pub. No.: US 2011/0209961 A1
(43) Pub. Date: Sep. 1, 2011

(54) VEHICLE DRIVE SHAFT AND VEHICLE EQUIPPED WITH VEHICLE DRIVE SHAFT

(75) Inventors: Takeo Yamamoto, Nissin-shi (JP); Shogo Yamano, Toyota-shi (JP); Keishi Kobata, Osaka-shi (JP)

(73) Assignee: TOYOTA JIDOSHA KABUSHIKI, KAISHA, TOYOTA-SHI (JP)

(21) Appl. No.: 13/123,831

(22) PCT Filed: Nov. 19, 2009
(86) PCT No.: PCT/IB2009/007503

§ 371 Date: Apr. 12, 2011

(30) Foreign Application Priority Data
Nov. 20, 2008 (JP) 2008-297151

(51) Int. Cl. F16H 45/02; F16C 3/02

(52) U.S. Cl. 192/3.28; 464/182

(57) ABSTRACT

A vehicle drive shaft includes: a first shaft portion, having a core shaft portion and a sleeve shaft portion coaxially arranged at one end, and a second shaft portion, having a spline hole portion and a second engagement protrusion at one end. A spline shaft portion and a first engagement protrusion are provided at distal ends of the core shaft portion and sleeve shaft portion. The spline hole portion is nonrotatably fixed to the spline shaft portion. The second engagement portion contacts the first engagement portion when a relative torsion allowable angle therebetween is larger than or equal to a gap. When the relative torsion allowable angle is smaller than the gap, torque is transmitted via the core shaft portion. When the relative torsion allowable angle is larger than or equal to the gap, torque is transmitted via not only the core shaft portion but also the sleeve shaft portion.

### BACKGROUND OF THE INVENTION

1. Field of the Invention

The invention relates to a vehicle drive shaft, which serves as a power transmission member, provided in a power transmission path of a vehicle and a vehicle equipped with the vehicle drive shaft.

2. Description of the Related Art

Vehicle drive shafts are known as rotary shafts provided in a power transmission path from a power source for propelling a vehicle to drive wheels in order to transmit power output from the power source to the drive wheels. For example, drive shafts described in Japanese Patent Application Publication No. 2004-9843 (JP-A-2004-9843) correspond to the above vehicle drive shafts. The drive shafts described in JP-A-2004-9843 are front wheel drive shafts provided between a front wheel differential gear unit and front wheels in a front-engine front-drive (FF) vehicle, and are used to transmit torque from the front wheel differential gear unit to the front wheels. Other than the above, the vehicle drive shafts, for example, include front wheel drive shafts used in an all-wheel drive vehicle, and rear wheel drive shafts provided between a rear wheel differential gear unit and rear wheels in a rear-wheel drive vehicle or all-wheel drive vehicle, such as a front-engine rear-drive (FR) type, a midship rear-drive (MR) type and a rear-engine rear-drive (RR) type.

Incidentally, in a drive train including the vehicle drive shafts according to the related art, there is a problem that drive train torsional resonance occurs to increase vibrations or noise, such as muffled noise in a vehicle cabin. The drive train torsional resonance, for example, occurs when, in a vehicle equipped with a lock-up clutch torque converter, the lock-up clutch is engaged at a relatively low rotational speed.

Then, although a technique is not within the public domain, it is conceivable that, for example, a vehicle drive shaft equipped with an intermediate shaft 100 as shown in FIG. 15 is used to decrease torsional rigidity of part of a drive train to thereby decrease the resonant frequency of the drive train, thus suppressing the torsional resonance. FIG. 16 is a cross-sectional view that is taken along the line XVI-XVI in FIG. 15. FIG. 17 is a cross-sectional view that is taken along the line XVII-XVII in FIG. 15. As shown in FIG. 15 to FIG. 17, the intermediate shaft 100 includes a core shaft portion 108 and a sleeve shaft portion 114. The core shaft portion 108 has a low torsional rigidity portion 102 at a middle portion in the axial direction, and has a first spline shaft portion 104 and a second spline shaft portion 106 respectively at both ends. The sleeve shaft portion 114 has a first spline hole portion 110 at one end and a second spline hole portion 112 at the other end. The first spline hole, portion 110 is fitted to the first spline shaft portion 104. The second spline hole portion 112 inserts the second spline shaft portion 106 with a predetermined gap in the circumferential direction. The predetermined gap is set so that, when torque transmitted to the intermediate shaft 100 exceeds a predetermined value and the relative torsional angle of the second spline shaft portion 106 with respect to the second spline hole portion 112 becomes a predetermined angle θ1, the second spline hole portion 112 contacts the second spline shaft portion 106 in the circumferential direction. Note that the predetermined value is obtained through an experiment, or the like, in advance as a transmission torque value, for example, when the lock-up clutch is engaged at a relatively low rotational speed.

For example, when the transmission torque is relatively low, that is, lower than or equal to the predetermined value, the thus configured intermediate shaft 100 is placed in a low torsional rigidity state where torque is transmitted via the low torsional rigidity portion 102. On the other hand, when the transmission torque is relatively high, that is, exceeds the predetermined value, the intermediate shaft 100 is placed in a high torsional rigidity state where torque is transmitted via the low torsional rigidity portion 102 and the sleeve shaft portion 114. Thus, with the vehicle drive shaft having the intermediate shaft 100, for example, when the lock-up clutch is engaged at a relatively low rotational speed, torsional rigidity of part of the drive train is decreased to decrease the resonant frequency of the drive train. Thus, it is possible to suppress drive train torsional resonance that is supposed to occur. In addition, when a relatively high toque is transmitted, for example, during acceleration, torsional rigidity is increased. Thus, it is possible to ensure durability of the vehicle drive shaft and stability of control over the vehicle. That is, it is possible to suppress occurrence of drive train torsional resonance while eliminating the problem that a uniform decrease in torsional rigidity decreases durability of the drive shaft and stability of control over the vehicle.

Incidentally, in the vehicle drive shaft having the intermediate shaft 100, there has been a problem that it is difficult to accurately set a predetermined angle θ1 that determines the variable characteristic of torsional rigidity of the intermediate shaft 100. That is, in order to set the gap in the circumferential direction between the second spline hole portion 112 and the second spline shaft portion 106 at a relatively small predetermined angle θ1 of, for example, approximately 2 to 5 degrees around the axis, there has been a problem that it is difficult to accurately machine the relative phases around the axis between the spline grooves of the first spline hole portion 110 and the spline grooves of the second spline hole portion 112 and the relative phases around the axis between the spline teeth of the first spline shaft portion 104 and the spline teeth of the second spline shaft portion 106.

### SUMMARY OF THE INVENTION

The invention provides a vehicle drive shaft that allows its components to be accurately and easily machined and that, in addition, is able to suppress occurrence of drive train torsional resonance while ensuring durability and stability of control, and also provides a vehicle equipped with the vehicle drive shaft.

A first aspect of the invention relates to a vehicle drive shaft that constitutes part of a power transmission path of a vehicle and that is provided to transmit power to a drive wheel. The vehicle drive shaft includes: a first shaft portion that has a core shaft portion and a sleeve shaft portion, which respectively have a first coupling portion and a first engagement portion at distal ends thereof, and which respectively have proximal ends integrally fixed to each other, and which extend longitudinally in the direction of the axis coaxially with each other; and a second shaft portion that is provided coaxially with the first shaft portion (44) and that has a second coupling portion and a second engagement portion, wherein the second coupling portion is fixed to the first coupling portion so that the second coupling portion is not rotatable about the axis relative to the first coupling portion, and the second engagement portion contacts the first engagement portion in a circumferential direction when a relative torsional angle between the first engagement portion and the second engagement portion is larger than or equal to a predetermined value. When the relative torsional angle between the first engagement portion and the second engagement portion is smaller than the predetermined value, a first torque is transmitted via the core shaft portion, and, when the relative torsional angle between the first engagement portion and the second engagement portion is larger than or equal to the predetermined value, a second torque that is larger than the first torque is transmitted via not only the core shaft portion but also the sleeve shaft portion.

With the vehicle drive shaft according to the first aspect of the invention, the first coupling portion and the first engagement portion are provided adjacent to each other in the direction of the axis at one end of the first shaft portion, and the second coupling portion and the second engagement portion are provided adjacent to each other in the direction of the axis at one end of the second shaft portion. Thus, those first coupling portion, first engagement portion, second coupling portion and second engagement portion may be accurately and easily machined. That is, when the first coupling portion, first engagement portion, second coupling portion and second engagement portion are machined, there is an advantage in that, for example, the reference in the direction of the axis may be set near a machining portion or so-called one chuck machining that a machining member is machined without changing a chuck holding portion is possible. Thus, it is possible to easily perform accurate machining. Therefore, the gap in the circumferential direction between the first engagement portion and the second engagement portion, which determines the variable characteristic of the torsional rigidity of the vehicle drive shaft, may be accurately set at a predetermined value.

Then, when the transmission torque is relatively low, for example, as in the case where the lock-up clutch is engaged in a relatively low rotational speed, the vehicle drive shaft is placed in a low torsional rigidity state where torque is transmitted via the core shaft portion (the first coupling portion and the second coupling portion). When the transmission torque is relatively high, for example, during acceleration, the vehicle drive shaft is placed in a high torsional rigidity state where torque is transmitted via not only the core shaft portion but also the sleeve shaft portion (the first engagement portion and the second engagement portion). Thus, for example, when the lock-up clutch is engaged at the relatively low rotational speed, the torsional rigidity of part of the drive train is decreased to decrease the resonance frequency of the drive train. Hence, it is possible to suppress occurrence of the drive train torsional resonance that is supposed to occur.

In addition, when a relatively high toque is transmitted, for example, during acceleration, torsional rigidity is increased. Thus, it is possible to ensure durability of the vehicle drive shaft and stability of control over the vehicle.

That is, with the vehicle drive shaft according to the first aspect of the invention, components of the vehicle drive shaft may be accurately and easily machined, and, in addition, it is possible to suppress occurrence of the drive train torsional resonance while ensuring durability and control stability.

In addition, the first coupling portion may be a spline shaft portion that is formed at the distal end of the core shaft portion, the first engagement portion may be a plurality of first engagement protrusions that protrude in the direction of the axis at a predetermined interval around the axis at the distal end of the sleeve shaft portion, the second coupling portion may be a spline hole portion that is bored at a center of one end surface of the second shaft portion, and the second engagement portion may be a plurality of second engagement protrusions that protrude from the one end surface of the second shaft portion in the direction of the axis at a predetermined interval around the axis so as to form a predetermined gap in the circumferential direction between the plurality of first engagement protrusions and the plurality of second engagement protrusions.

Therefore, the first engagement protrusions are formed in such a manner that, for example, the distal end surface of the sleeve shaft portion is set as the reference in the direction of the axis and then the distal end surface is grooved at a predetermined interval around the axis. The spline shaft portion is formed in such a manner that, for example, the core shaft portion that protrudes from the distal end surface of the sleeve shaft portion, which serves as the reference in the direction of the axis, in the direction of the axis by the predetermined length is gear-cut. In addition, the second engagement protrusions are formed in such a manner that, for example, at one end of the second shaft portion formed in a closed-end cylindrical shape having a bottom surface that corresponds to the end surface of the second shaft portion, the one end surface is set as the reference in the direction of the axis, and then the cylindrical portion that protrudes from the outer peripheral side of the one end surface in the direction of the axis is grooved at a predetermined interval around the axis. The spline hole portion is formed in such a manner that, for example, the pilot hole bored at the center of the one end surface is internally gear-cut or die indented. Thus, when the first engagement protrusions and the spline shaft portion in the first shaft portion are machined, and when the second engagement protrusions and the spline hole portion in the second shaft portion are machined, there is an advantage in that for example, so-called one chuck machining that a machining member is machined without changing a chuck holding portion is possible or the reference in the direction of the axis may be set near a machining portion. Thus, it is possible to easily perform accurate machining.

A second aspect of the invention relates to a vehicle that includes the vehicle drive shaft according to the first aspect of the invention.

According to the second aspect of the invention, components of the drive shaft may be accurately and easily machined, and, in addition, it is possible to provide a vehicle that is able to suppress occurrence of the drive train torsional resonance while ensuring durability and control stability.

In addition, the vehicle may include: a torque converter that is connected to a power source for propelling the vehicle, that transmits power from the power source and that has a lock-up clutch; and an automatic transmission that transmits the power from the torque converter to the drive shaft. The predetermined value of the relative torsional angle may be a relative torsional angle between the first engagement portion and the second engagement portion around the axis of the drive shaft when the automatic transmission is set at a lowest speed gear, and when a maximum torque transmittable to the drive shaft at the time when the lock-up clutch is engaged is applied to the drive shaft.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view that shows the schematic configuration of a vehicle drive device equipped with vehicle drive shafts according to an embodiment of the invention and a relevant portion of a control system provided for the vehicle;

FIG. 2 is a map that shows a prestored relationship related to an operating range of a lock-up clutch of a torque converter shown in FIG. 1, the relationship being set in two-dimensional coordinates having a vehicle speed axis and a throttle valve opening degree axis;

FIG. 3 is an enlarged view that shows an intermediate shaft of the vehicle drive shaft shown in FIG. 1, that is, a portion indicated by the arrow III in FIG. 1;

FIG. 4 is a cross-sectional view that shows a portion of the intermediate shaft in FIG. 3, indicated by the arrow IV;

FIG. 5 is a cross-sectional view taken along the line V-V in FIG. 4, showing a first shaft portion only;

FIG. 6 is a partially cross-sectional view taken along the line VI-VI in FIG. 5 at the other end while the outer shape of one end of the first shaft portion shown in FIG. 3 remains unchanged;

FIG. 7 is a cross-sectional view taken along the line VII-VII in FIG. 4, showing a second shaft portion only;

FIG. 8 is a partially cross-sectional view taken along the line VIII-VIII in FIG. 7 at the other end while the outer shape of one end of the second shaft portion shown in FIG. 3 remains unchanged;

FIG. 9 is a cross-sectional view taken along the line IX-IX over the intermediate shaft shown in FIG. 3, showing an engaged portion between the first shaft portion and the second shaft portion;

FIG. 10 is a graph that shows the characteristic related to torsion of the vehicle drive shaft shown in FIG. 1 and that shows the relationship between the transmission torque of the vehicle drive shaft and the torsional angle of a core shaft;

FIG. 11 is a view that shows an equivalent four degrees of freedom model simply illustrating a torsional vibration system of the vehicle drive device shown in FIG. 1 using masses and dampers;

FIG. 12 is a view that shows the index of torsion, that is, the relative amplitude among the masses, as the result of calculating the equation of motion of the equivalent four degrees of freedom model shown in FIG. 11;

FIG. 13 is a graph that shows the vibration characteristic of the entire vibration system of the vehicle equipped with the vehicle drive shafts shown in FIG. 1, and that shows a portion related to a second-order torsional resonance mode within the relationship between the engine rotational speed and the vibration transmission level;

FIG. 14 is a partially cross-sectional view of a first shaft portion of a vehicle drive shaft according to another embodiment of the invention;

FIG. 15 is a partially cross-sectional view of an intermediate shaft of a vehicle drive shaft, which is not within the public domain, improved from the one according to the related art in order to suppress torsional resonance;

FIG. 16 is a cross-sectional view that is taken along the line XVI-XVI over the drive shaft shown in FIG. 15; and

FIG. 17 is a cross-sectional view that is taken along the line XVII-XVII over the drive shaft shown in FIG. 15.

### DETAILED DESCRIPTION OF EMBODIMENTS

Hereinafter, an embodiment of the invention will be described with reference to the accompanying drawings. Note that the drawings in the following embodiment are appropriately simplified or modified and do not always accurately illustrate the scale ratio, shape, and the like, of portions.

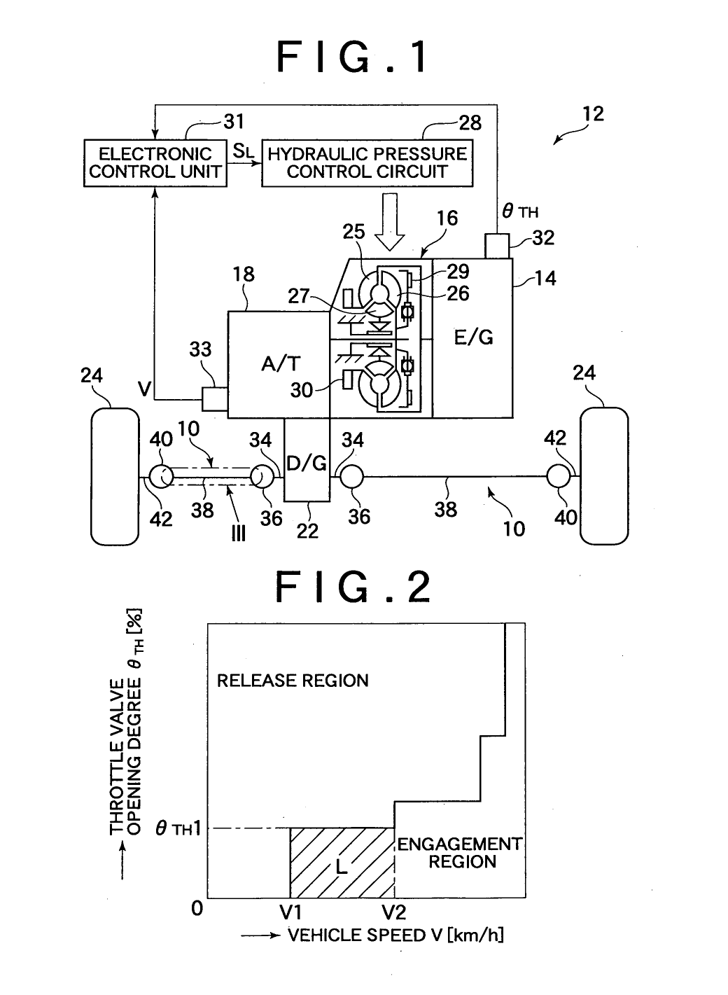

FIG. 1 is a view that shows the schematic configuration of a vehicle drive device 12 equipped with vehicle drive shafts (vehicle power transmission members) 10 according to an embodiment of the invention and a relevant portion of a control system provided for the vehicle. As shown in FIG. 1, the drive device 12 is used for a front-engine front-drive (FF) vehicle, and includes an engine 14 as a power source for propelling the vehicle. The engine 14 is, for example, formed of an internal combustion engine, such as a gasoline engine and a diesel engine. Power output from the engine 14 is transmitted to a differential gear unit 22 via a well-known torque converter 16 and automatic transmission 18, and is distributed from the differential gear unit 22 to a pair of drive wheels 24 via a pair of vehicle drive shafts 10. That is, the vehicle drive shafts 10 according to the present embodiment constitute part of a power transmission path of the vehicle from the engine 14 to the drive wheels 24, and are provided to transmit power, transmitted from the engine 14 to the differential gear unit 22, to the drive wheels 24.

Here, the torque converter 16 includes a pump impeller 25, a turbine impeller 26 and a stator impeller 27. The pump impeller 25 is coupled to a crankshaft (not shown) that serves as an output shaft of the engine 14, and is driven for rotation by the engine 14 to generate fluid flow caused by flow of hydraulic fluid in the torque converter 16. The turbine impeller 26 is coupled to an input shaft of the automatic transmission 18 and is driven for rotation by fluid flow from the pump impeller 25. The stator impeller 27 is arranged in fluid flow from the turbine impeller 26 to the pump impeller 25. The torque converter 16 amplifies torque while transmitting power via hydraulic fluid. In addition, a lock-up clutch 29 is provided between the pump impeller 25 and the turbine impeller 26. The lock-up clutch 29 is engaged or released by hydraulic pressure supplied from a hydraulic pressure control circuit 28. In the thus configured torque converter 16, the lock-up clutch 29 is completely engaged to mechanically directly couple the pump impeller 25 to the turbine impeller 26, and then the crankshaft of the engine 14 and the input shaft of the automatic transmission 18 are integrally rotated. Thus, in comparison with the case where power is transmitted via hydraulic fluid, torque amplification effect cannot be obtained; however, power transmission efficiency is improved. In addition, a rotary member of a mechanical oil pump 30 is coupled to the pump impeller 25. The oil pump 30 is used to supply the hydraulic pressure control circuit 28 with hydraulic pressure used for shift control of the automatic transmission 18, engagement and release control of the lock-up clutch 29, or the like.

An electronic control unit 31 includes a so-called microcomputer that includes a CPU, a RAM, a ROM, an input/output interface, and the like. The electronic control unit 31 is, for example, supplied with a signal that indicates a throttle valve opening degree θ_{TH} from a throttle sensor 32, a signal that indicates a vehicle speed V from a vehicle speed sensor 33, and the like. The electronic control unit 31 utilizes the temporary storage function of the RAM and carries out signal processing in accordance with a program prestored in the ROM to execute output control of the engine 14, shift control of the automatic transmission 18, engagement and release control of the lock-up clutch 29 of the torque converter 16, or the like. The engagement and release control of the lock-up clutch 29, for example, determines an operating region of the lock-up clutch 29 on the basis of an actual, throttle valve opening degree θ_{TH} and an actual vehicle speed V by referring to the prestored relationship (map, lock-up region line map) formed of the operating region, that is, a release region and an engagement region, of the lock-up clutch 29 set in two-dimensional coordinates having a vehicle speed axis and a throttle valve opening degree axis as shown in FIG. 2, and outputs a lock-up control instruction signal S_{L} for shifting the operating state of the lock-up clutch 29 to the hydraulic pressure control circuit 28 on the basis of the determined operating region. The hydraulic pressure control circuit 28, for example, actuates an internal electromagnetic valve, and the like, to control hydraulic pressure supplied to the lock-up clutch 29 so as to shift the operating state of the lock-up clutch 29 in accordance with the lock-up control instruction signal S_{L}.

Referring back to FIG. 1, the pair of vehicle drive shafts 10 each include a first coupling shaft (inboard shaft member) 34, an intermediate shaft 38 and a second coupling shaft (outboard shaft member) 42. One end of the first coupling shaft 34 is coupled to an output member of the differential gear unit 22. One end of the intermediate shaft 38 is coupled to the other end of the first coupling shaft 34 via a universal joint 36. One end of the second coupling shaft 42 is coupled to the intermediate shaft 38 via a universal joint 40. The intermediate shaft 38 of the vehicle drive shaft 10 on the left side in FIG. 1 and the intermediate shaft 38 of the vehicle drive shaft 10 on the right side in FIG. 1 only differ from each other in the axial length, and, other than that, have similar structures to each other. Hereinafter, the intermediate shaft 38 of the drive shaft 10 on the left side in FIG. 1 will be described.

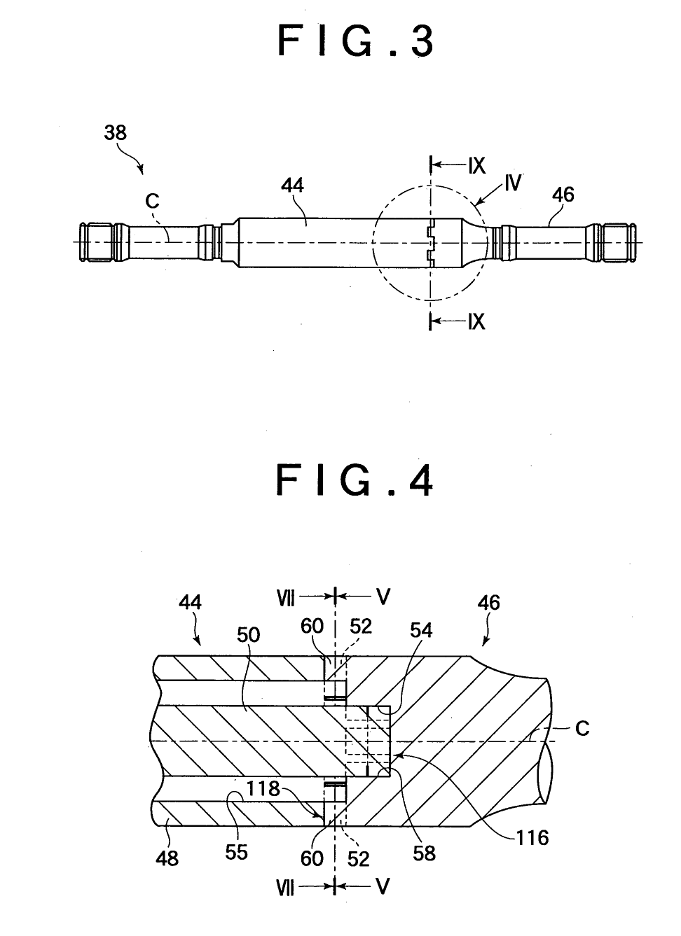

FIG. 3 is an enlarged view that shows the intermediate shaft 38 on the left side in FIG. 1, that is, a portion indicated by the arrow III in FIG. 1. In addition, FIG. 4 is a cross-sectional view taken along the line IV-IV in FIG. 3. As shown in FIG. 3 and FIG. 4, the intermediate shaft 38 is an integrated member of a first shaft portion 44 and a second shaft portion 46. The first shaft portion 44 and the second shaft portion 46 are provided coaxially with respect to each other along an axis C in a direction in which torque is transmitted. One ends of the first shaft portion 44 and the second shaft portion 46 are coupled to each other.

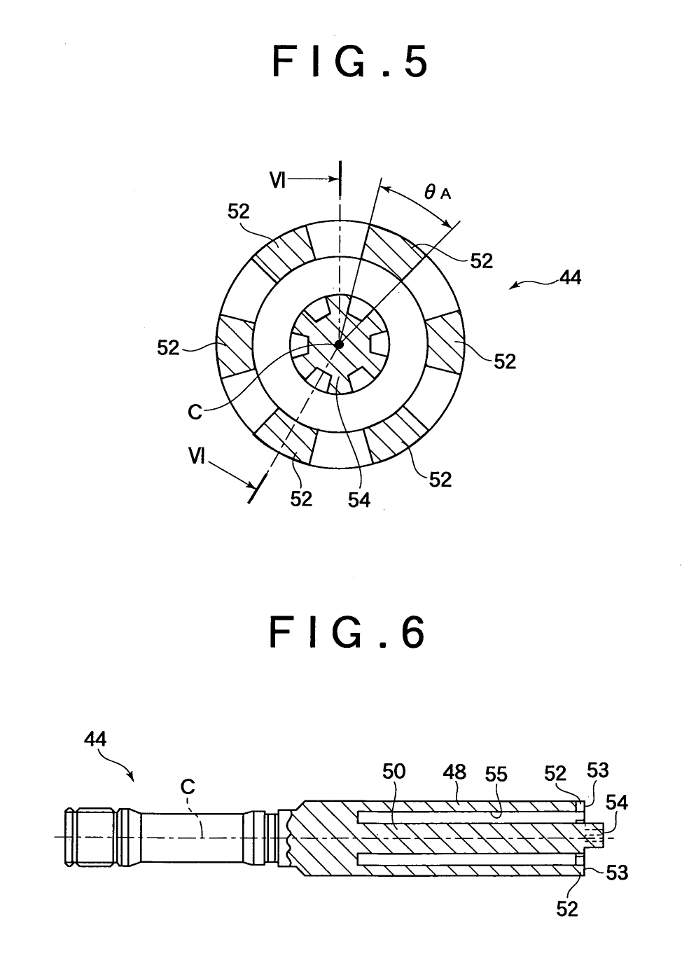

FIG. 5 is a cross-sectional view taken along the line V-V in FIG. 4, showing the first shaft portion 44 only. FIG. 6 is a partially cross-sectional view taken along the line VI-VI in FIG. 5 at the other end while the outer shape of one end of the first shaft portion 44 remains unchanged. As shown in FIG. 5 and FIG. 6, the first shaft portion 44 is a shaft member that includes a hollow cylindrical sleeve shaft portion 48 and a columnar core shaft portion 50. The sleeve shaft portion 48 and the core shaft portion 50 respectively have proximal ends that are integrally fixed to each other near a middle portion in the direction of the axis C. The sleeve shaft portion 48 and the core shaft portion 50 are formed longitudinally in the direction of the axis C on the distal end side with respect to the proximal ends and are provided coaxially with each other.

The sleeve shaft portion 48 has a plurality of first engagement protrusions 52 that protrude in the direction of the axis C at the distal end and that are formed at predetermined intervals around the axis C. In the present embodiment, these plurality of first engagement protrusions 52 are provided, for example, at equiangular intervals of 60 degrees around the axis C, and are formed so that the circumferential length of each first engagement protrusion 52 is a length that occupies the range of a predetermined angle θ_{A} about the axis C as shown in FIG. 5.

The core shaft portion 50 has a spline shaft portion 54 that is formed at the distal end and that protrudes from the distal end surface of the sleeve shaft portion 48 (first engagement protrusions 52) in the direction of the axis C by a predetermined length. In the present embodiment, the spline shaft portion 54 has a square-spline shaft that, for example, has a plurality of square-spline teeth at equiangular intervals of 60 degrees around the axis C, and is formed so that the relative phases around the axis C between the plurality of spline grooves and the plurality of first engagement protrusions 52 coincide with each other.

In the present embodiment, the entire first shaft portion 44 including the core shaft portion 50 and the sleeve shaft portion 48 is integrally formed of a member of the same material. The first shaft portion 44 is, for example, manufactured as follows. In a state where one end of an axial material is fixed (chucked) to a machine tool, an end surface of the other end is cut in the direction of the axis C by a machining center (numerically controlled machine tool that performs various types of machining while automatically replacing multiple types of tools in accordance with an input instruction (program)). Thus, a closed-end annular groove 55 is formed, and the core shaft portion 50 is formed to protrude from the distal end surface 53 of the sleeve shaft portion 48 in the direction of the axis C by a predetermined length. Subsequently, the distal end surface 53 of the sleeve shaft portion 48 is set as the reference in the direction of the C axis, and the distal end surface 53 is grooved at equiangular intervals of, for example, 60 degrees around the axis C to form the first engagement protrusions 52. Then, the distal end of the core shaft portion 50 that protrudes from the distal end surface 53 in the direction of the axis C is gear-cut to form the spline shaft portion 54.

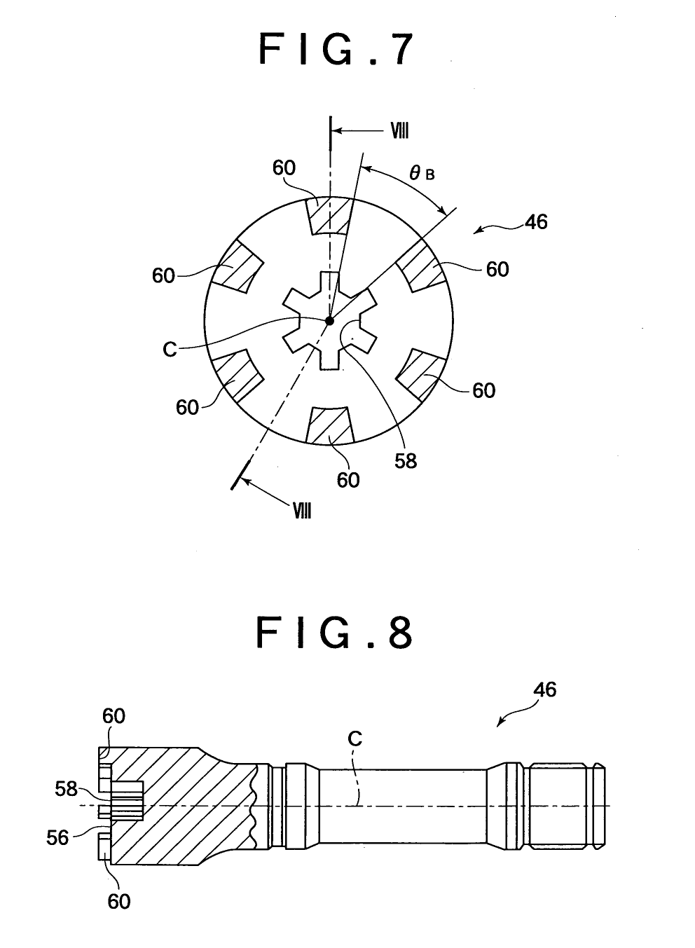

FIG. 7 is a cross-sectional view taken along the line VII-VII in FIG. 4, showing the second shaft portion 46 only. FIG. 8 is a partially cross-sectional view taken along the line VIII-VIII in FIG. 7 at the other end while the outer shape of one end of the second shaft portion 46 remains unchanged. As shown in FIG. 7 and FIG. 8, the second shaft portion 46 is an axial member that has a spline hole portion 58 and a plurality of second engagement protrusions 60 at one end. The spline hole portion 58 is bored at the center of an end surface 56 thereof. The plurality of second engagement protrusions 60 protrude from the end surface 56 in the direction of the axis C and are formed at predetermined intervals around the axis C.

In the present embodiment, the spline hole portion 58 has a square-spline hole that has a plurality of square-spline grooves at equiangular intervals of, for example, 60 degrees around the axis C. Then, as shown in FIG. 4, the spline hole portion 58 is fixedly fitted to the spline shaft portion 54 so that the spline hole portion 58 is not rotatable relative to the spline shaft portion 54 around the axis C.

In the present embodiment, the plurality of second engagement protrusions 60 are provided at equiangular intervals of, for example, 60 degrees around the axis C, and are formed so that the circumferential length of each groove between the adjacent second engagement protrusions 60 is a length that occupies the range of a predetermined angle θ_{B} about the axis C as shown in FIG. 7. The plurality of second engagement protrusions 60 are formed so that the relative phases around the axis C between the plurality of second engagement protrusions 60 and the plurality of square-spline grooves of the spline hole portion 58 coincide with each other.

In the present embodiment, the entire second shaft portion 46 including the plurality of second engagement protrusions 60 is integrally formed of a member having the same material. The second shaft portion 46 is, for example, manufactured as follows. In a state where one end of an axial material is fixed (chucked) by a machine tool, the end surface of the other end is cut by a machining center, or the like, to form the other end into a closed-end cylindrical shape having the end surface 56 as a bottom surface. Subsequently, a pilot hole bored at the center of the end surface 56 is, for example, internally gear-cut or die indented to form the spline hole portion 58. Then, the cylindrical portion that protrudes from the outer peripheral side of the end surface 56 in the direction of the axis C is grooved at equiangular intervals of, for example, 60 degrees around the axis C to form the second engagement protrusions 60.

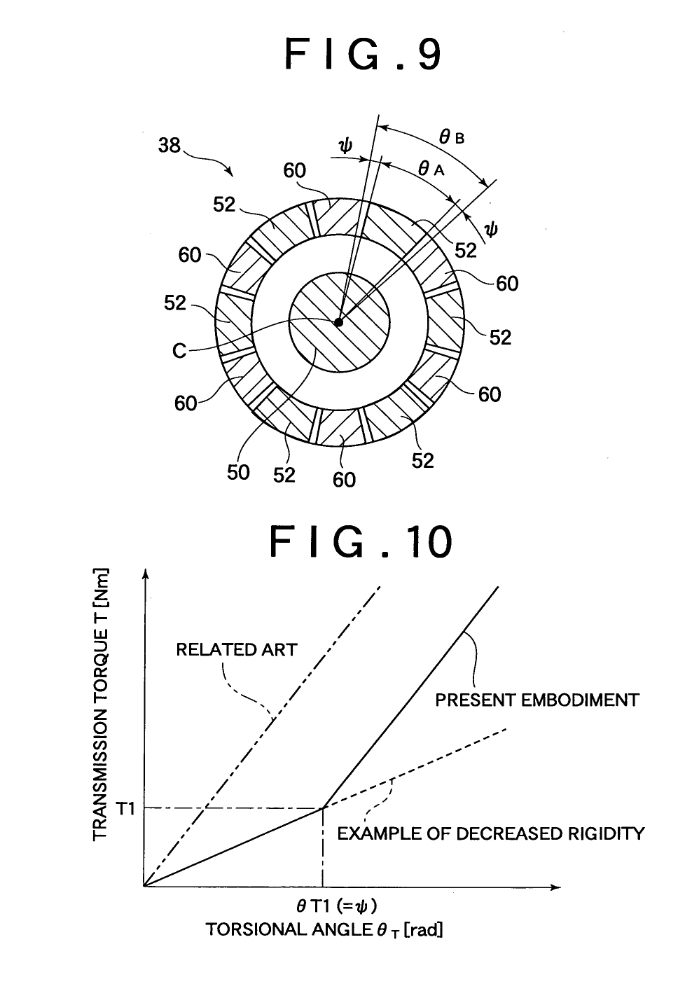

Then, as shown in FIG. 9, which is the cross-sectional view taken along the line IX-IX over the intermediate shaft 38 in FIG. 3, predetermined gaps ip are formed in the circumferential direction between the plurality of second engagement protrusions 60 and the plurality of first engagement protrusions 52. When the relative torsion allowable angle (relative torsional angle) between the adjacent second engagement protrusion 60 and first engagement protrusion 52 is larger than or equal to a predetermined value, that is, the gap 1p, the second engagement protrusions 60 contact the first engagement protrusions 52 in the circumferential direction. The gap ψ is expressed by the mathematical expression (1) using the predetermined angles θ_{A} and θ_{B}. Note that the gap ψ is a value that is experimentally obtained in advance as the relative torsion allowable angle between the adjacent first engagement protrusion 52 and second engagement protrusion 60 when the transmission torque T of the intermediate shaft 38 is, for example, a predetermined torque T1 set at 200 [N·m]. In the present embodiment, the gap ψ is, for example, set at approximately 4 degrees.

θ_{B}=θ_{A}+2×ψ (1)

In the vehicle drive shaft 10 having the thus configured intermediate shaft 38, when the transmission torque T is relatively low, that is, lower than or equal to the predetermined torque T1 (see FIG. 10, which will be described later), the first engagement protrusions 52 do not contact the second engagement protrusions 60. Thus, the vehicle drive shaft 10 is placed in a low torsional rigidity state where torque is transmitted through the core shaft portion 50 only. On the other hand, when the transmission torque T is relatively high, that is, exceeds the predetermined torque T1, the first engagement protrusions 52 contact the second engagement protrusions 60. Thus, the vehicle drive shaft 10 is placed in a high torsional rigidity state where torque is transmitted through not only the core shaft portion 50 but also the sleeve shaft portion 48. That is, when the relative torsional angle between the first engagement protrusions 52 and the second engagement protrusions 60 is smaller than the gap (predetermined value) ψ, torque is transmitted only through a fitting portion 116 formed of the spline shaft portion 54 and the spline hole portion 58. On the other hand, when the relative torsional angle between the first engagement protrusions 52 and the second engagement protrusions 60 reaches the gap (predetermined value) ψ, torque larger than the above torque is transmitted through not only the fitting portion 116 but, also a fitting portion 118 formed of the first engagement protrusions 52 and the second engagement protrusions 60.

Note that in the present embodiment, the first engagement protrusions 52 may be regarded as a first engagement portion according to the aspect of the invention, and the spline shaft portion 54 may be regarded as a first coupling portion according to the aspect of the invention. In addition, the second engagement protrusions 60 may be regarded as a second engagement portion according to the aspect of the invention, and the spline hole portion 58 may be regarded as a second coupling portion according to the aspect of the invention.

FIG. 10 is a graph that shows the characteristic related to torsion of the vehicle drive shaft 10 and that shows the relationship between the transmission torque T of the vehicle drive shaft 10 and the torsional angle θT of the distal end of the core shaft portion 50 with respect to the proximal end of the core shaft portion 50. Note that the torsional angle θT corresponds to the relative torsion angle between the first engagement protrusions 52 and the second engagement protrusions 60. As shown in FIG. 10, in the thus configured vehicle drive shaft 10, when the transmission torque T is, for example, lower than the predetermined torque T1 set at 200 [N·m] and then torque is transmitted through the core shaft portion 50 only, in comparison with the case where the transmission torque T exceeds the predetermined torque T1 and then torque is transmitted through the core shaft portion 50 and the sleeve shaft portion 48, torsional rigidity is reduced by 50 percent to increase the rate of increase in torsional angle θT with respect to the rate of increase in transmission torque T. The predetermined torque T1 is experimentally obtained in advance. In the present embodiment, for example, when various driving patterns are carried out by simulation, actual driving test, or the like, the maximum torque at the time when the lock-up clutch 29 is engaged is set as the predetermined torque T1 in a low speed region L within an engagement region of the lock-up clutch 29 from a predetermined speed V1 to a predetermined speed V2 shown in FIG. 2 at a predetermined gear. Here, as shown in FIG. 2, a throttle valve opening degree θ_{TH}1 becomes a throttle valve opening degree θ_{TH} at which the transmission torque T is maximum in a low speed region L, that is, just before the operating state of the lock-up clutch 29 shifts from an engaged state into a released state, is the throttle valve opening degree θ_{TH} corresponding to the predetermined torque T1. By so doing, in the intermediate shaft 38, in comparison with the torsional rigidity, for example, during acceleration, the torsional rigidity at the time when the lock-up clutch 29 is engaged in the low speed region L is decreased. Specifically, in the intermediate shaft 38 according to the present embodiment, the torsional rigidity, at the time when the transmission torque T applied to the vehicle drive shaft 10 during engagement of the lock-up clutch in the lower speed region L is maximum, is lower than the torsional rigidity at the time when relatively large torque that causes the torsional angle θT to be larger than or equal to the predetermined torsional angle θT1 (=ψ) that is obtained when the transmission torque T reaches the predetermined transmission torque T1 set at 200 [N·m] is transmitted because of high load applied, for example, during acceleration, or the like.

Note that, as indicated by the alternate long and two short dashed lines in FIG. 10, in the drive shaft 70 according to the related art, of which the torsional rigidity does not change on the basis of the transmission torque T, the torsional rigidity at the time when the lock-up clutch 29 is engaged in the low speed region L is equal to the torsional rigidity at the time when relatively large torque is transmitted because of high load applied, for example, during acceleration. Thus, in the drive shaft 70 according to the related art, the torsional rigidity is generally designed in correspondence with when high load is applied in order to ensure durability of the drive shaft and stability of control over the vehicle. Note that, as indicated by the dotted line in FIG. 10, in a drive shaft that is an example of which the rigidity is decreased in comparison with the related art, it is difficult to ensure durability of the drive shaft and stability of control over the vehicle when high load is applied.

Hereinafter, the vibration characteristic of the drive train of the vehicle equipped with the vehicle drive shaft 10 according to the present embodiment will be described.

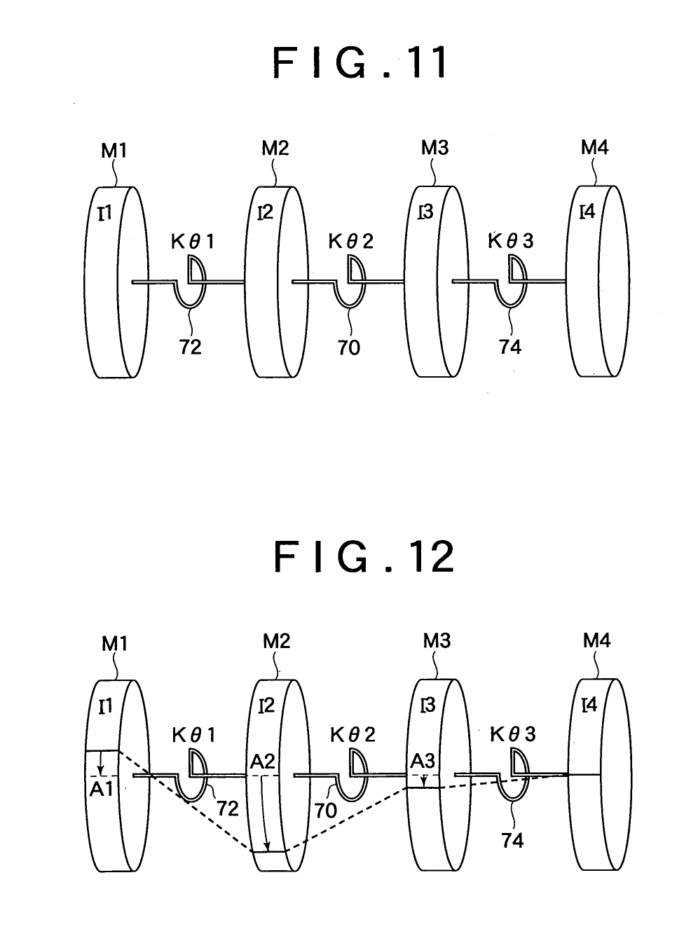

First, the torsional vibration of the vehicle equipped with the drive shafts 10 according to the related art shown in FIG. 10 will be considered. FIG. 11 is a view that shows an equivalent four degrees of freedom model illustrating the torsional vibration system of the vehicle drive device 12 using masses and dampers. As shown in FIG. 11, a mass M1 includes the crankshaft of the engine 14 and a primary side of the torque converter 16 (the input shaft and pump impeller 25 of the torque converter 16), and has a moment of inertia I1. In addition, a mass M2 includes a secondary side of the torque converter 16 (the output shaft and turbine impeller 26 of the torque converter 16), the automatic transmission 18 and the differential gear unit 22, and has a moment of inertia I2. In addition, a mass M3 includes the drive wheels 24, and has a moment of inertia I3. In addition, a mass M4 includes a suspension and a vehicle body, and has a moment of inertia I4. In addition, the mass M1 and the mass M2 are coupled to each other by a lock-up damper 72 of the torque converter 16, having a torsional rigidity Kθ1. In addition, the mass M2 and the mass M3 are coupled to each other by the drive shafts 70 having a torsional rigidity Kθ2. In addition, the mass M3 and the mass M4 are coupled to each other by tires 74 of the drive wheels 24, having a torsional rigidity Kθ3.

By applying the equation of motion of the equivalent four degrees of freedom model shown in FIG. 11 to various vehicles and calculating the equitation of motion, that is, for example, by simulating the behavior of the torsional vibration of the equivalent four degrees of freedom model shown in FIG. 11 using an electronic computer, it turns out that a second-order torsional resonance mode has the most influence on the torsional vibration in a low rotational speed region, that is, an engine rotational speed region of, for example, about 1000 to 1500 [rpm]. FIG. 12 shows the second-order torsional resonance mode (vibration mode), and shows the indices of torsion of the masses M1 to M3 (relative amplitudes or angles among the masses) using the lengths of the arrows A1, A2 and A3. Note that in FIG. 12, the mass M4 almost does not move. As shown in FIG. 12, in the second-order torsional resonance mode, the mass M2 has the maximum torsion (relative amplitude), so it is conceivable that the torsional rigidity Kθ2 of the vehicle drive shafts 70 is decreased in order to effectively reduce resonance in this drive mode.

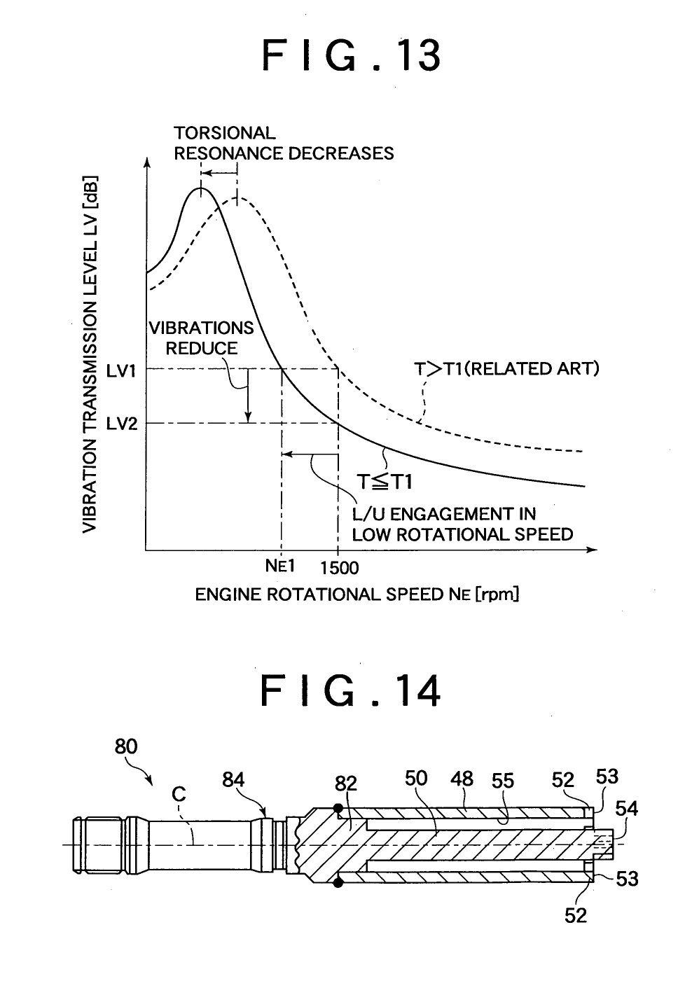

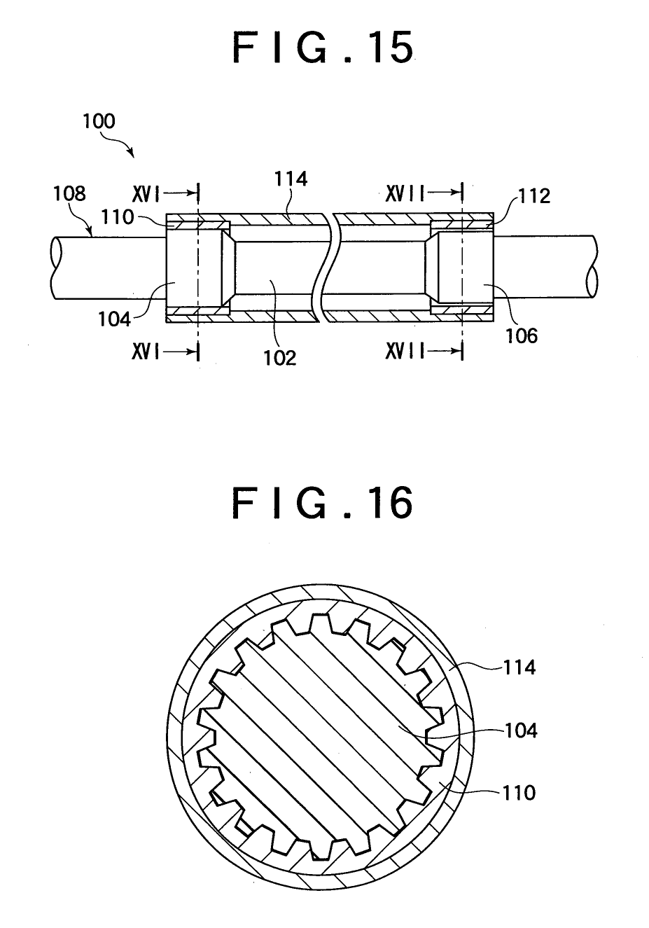

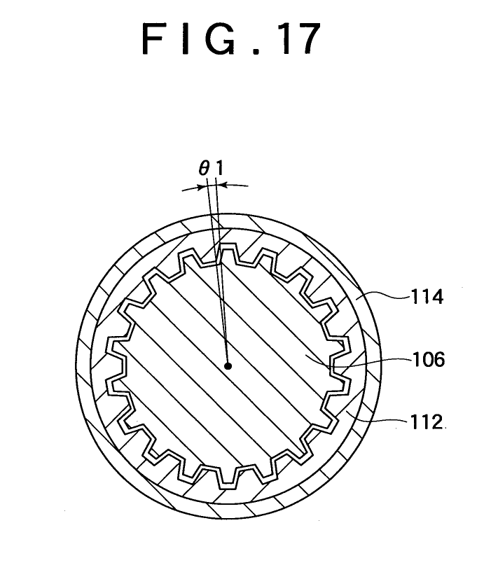

FIG. 13 is a graph that shows part of the vibration characteristic of the entire vibration system of the vehicle equipped with the vehicle drive shafts 10 according to the present embodiment, and is a graph that shows the relationship between the engine rotational speed N_{E} of the engine 14 and the vibration transmission level LV. In FIG. 13, the dotted line shows the relationship between the engine rotational speed N_{E} and the vibration transmission level LV when the transmission torque T exceeds the predetermined torque T1, and, in addition, shows the relationship between the engine rotational speed N_{E} and the vibration transmission level LV in the vibration system of the vehicle equipped with the drive shafts 70 according to the related art. Note that, in the vehicle drive shaft 10 according to the present embodiment, the torsional rigidity at the time when the transmission torque T exceeds the predetermined torque T1 is equal to that of the drive shaft 70 according to the related art. Then, the solid line indicates the relationship between the engine rotational speed N_{E} and the vibration transmission level LV when the transmission torque T is lower than or equal to the predetermined torque T1. As shown in FIG. 13, the solid line is shifted in a direction in which a resonance point decreases, that is, in a direction in which the engine rotational speed decreases, as compared with the dotted line. That is, in the vehicle drive shaft 10 according to the present embodiment, when the lock-up clutch 29 is engaged in the low speed region L in which the transmission torque T is lower than or equal to the predetermined torque T1, in comparison with the case where high load is applied, for example, during acceleration, or the like, in which the transmission torque T exceeds the predetermined torque T1, the torsional rigidity is decreased to decrease the resonance frequency. By so doing, with the vehicle drive shaft 10 according to the present embodiment, when the lock-up clutch 29 is engaged in the low speed region L in which the transmission torque T is lower than or equal to the predetermined torque T1, in comparison with the vehicle equipped with the drive shafts 70 according to the related art, even when the engine rotational speed N_{E} is equal at, for example, 1500 [rpm], the vibration transmission level LV is decreased from a vibration transmission level LV1 to a predetermined vibration transmission level LV2. Furthermore, with the vehicle drive shaft 10 according to the present embodiment, when the lock-up clutch 29 is engaged in the low speed region L in which the transmission torque T is lower than or equal to the predetermined torque T1, in comparison with the vehicle equipped with the drive shafts 70 according to the related art, even when the engine rotational speed N_{E} is a predetermined value N_{E}1 that is lower than 1500 [rpm], the vibration transmission level LV is suppressed to the same value, that is, the predetermined vibration transmission level LV1.

As described above, with the vehicle drive shaft 10 according to the present embodiment, the vehicle drive shaft 10 constitutes part of the power transmission path of the vehicle and is provided to transmit power to the drive wheel 24. The vehicle drive shaft 10 includes the first shaft portion 44 and the second shaft portion 46. The first shaft portion 44 has the core shaft portion 50 and the sleeve shaft portion 48 at one end thereof. The core shaft portion 50 and the sleeve shaft portion 48 are formed longitudinally in the direction of the axis C and coaxially fixed to each other. The spline shaft portion 54 and the first engagement protrusions 52 are respectively provided for the core shaft portion 50 and the sleeve shaft portion 48. The second shaft portion 46 is provided coaxially with the first shaft portion 44. The second shaft portion 46 has the spline hole portion 58 and the second engagement protrusions 60 at one end thereof. The spline hole portion 58 is fixed to the spline shaft portion 54 so that the spline hole portion 58 is not rotatable relative to the spline shaft portion 54 around the axis C. The second engagement protrusions 60 contact the first engagement protrusions 52 in the circumferential direction when the relative torsion allowable angle between the first engagement protrusions 52 and the second engagement protrusions 60 is larger than or equal to the predetermined value, that is, the gap ψ. When the relative torsion allowable angle between the first engagement protrusions 52 and the second engagement protrusions 60 is smaller than the gap ψ, the vehicle drive shaft 10 transmits torque via the core shaft portion 50 only. When the relative torsion allowable angle between the first engagement protrusions 52 and the second engagement protrusions 60 is larger than or equal to the gap ψ, the vehicle drive shaft 10 transmits torque that is larger than the above torque via not only the core shaft portion 50 but also the sleeve shaft portion 48. Then, the spline shaft portion 54 and the first engagement protrusions 52 are provided adjacent to each other in the direction of the axis C at one end of the first shaft portion 44, and the spline hole portion 58 and the second engagement protrusions 60 are provided adjacent to each other in the direction of the axis C at one end of the second shaft portion 46. Thus, those spline shaft portion 54, first engagement protrusions 52, spline hole portion 58 and second engagement protrusions 60 may be accurately and easily machined. That is, when the spline shaft portion 54, first engagement protrusions 52, spline hole portion 58 and second engagement protrusions 60 are machined, there is an advantage in that, for example, the reference in the direction of the axis C may be set near a machining portion or so-called one chuck machining that a machining member is machined without changing a chuck holding portion is possible. Thus, it is possible to easily perform accurate machining. Therefore, the gap ψ in the circumferential direction between the first engagement protrusions 52 and the second engagement protrusions 60, which determines the variation characteristic of the torsional rigidity of the vehicle drive shaft 10, may be accurately set at a predetermined value.

Then, when the transmission torque T is relatively low, for example, as in the case where the lock-up clutch 29 is engaged in the low speed region L, the vehicle drive shaft 10 is placed in a low torsional rigidity state where torque is transmitted via the core shaft portion 50 (the spline shaft portion 54 and the spline hole portion 58). When the transmission torque T is relatively high, for example, during acceleration, the vehicle drive shaft 10 is placed in a high torsional rigidity state where torque is transmitted via not only the core shaft portion 50 but also the sleeve shaft portion 48 (the first engagement protrusions 52 and the second engagement protrusions 60). Thus, for example, when the lock-up clutch 29 is engaged in the low speed region L, the torsional rigidity of part of the drive train is decreased to decrease the resonance frequency of the drive train. Hence, it is possible to suppress occurrence of the drive train torsional resonance that is supposed to occur.

Then, for example, when relatively high torque is transmitted during acceleration, or the like, the torsional rigidity is increased, so it is possible to ensure durability of the vehicle drive shaft 10 and stability of control over the vehicle.

That is, with the vehicle drive shaft 10 according to the present embodiment, components of the vehicle drive shaft 10 may be accurately and easily machined, and, in addition, it is possible to suppress occurrence of the drive train torsional resonance while ensuring durability and control stability.

In addition, with the vehicle drive shaft 10 according to the present embodiment, the spline shaft portion 54 is a square-spline shaft formed at the distal end of the core shaft portion 50, protruding from the distal end surface 53 of the sleeve shaft portion 48 by a predetermined length, the first engagement protrusions 52 are a plurality of protrusions that protrude in the direction of the axis C and that are formed at predetermined intervals around the axis C at the distal end of the sleeve shaft portion 48, the spline hole portion 58 has a spline hole bored at the center of the end 56 of the second shaft portion 46, and the second engagement protrusions 60 are a plurality of protrusions that protrude from the end surface 56 of the second shaft portion 46 in the direction of the axis C and that are formed at predetermined intervals around the axis C so as to form the predetermined gaps ψ in the circumferential direction between the plurality of first engagement protrusions 52 and the second engagement protrusions 60. Therefore, the first engagement protrusions 52 are formed in such a manner that, for example, the distal end surface 53 of the sleeve shaft portion 48 is set as the reference in the direction of the axis C and then the distal end surface 53 is grooved at predetermined intervals around the axis C. The spline shaft portion 54 is formed in such a manner that, for example, the core shaft portion 50 that protrudes from the distal end surface 53 of the sleeve shaft portion, which serves as the reference in the direction of the axis C, in the direction of the axis C by the predetermined length is gear-cut. In addition, the second engagement protrusions 60 are formed in such a manner that, for example, the end surface 56 is set as the reference in the direction of the axis C at one end of the second shaft portion 46 formed in a closed-end cylindrical shape having a bottom surface that corresponds to the end surface 56, and then the cylindrical portion that protrudes from the outer peripheral side of the end surface 56 in the direction of the axis C is grooved at intervals of 60 degrees around the axis C. The spline hole portion 58 is formed in such a manner that, for example, the pilot hole bored at the center of the end surface 56 is internally gear-cut or die indented. Thus, when the first engagement protrusions 52 and the spline shaft portion 54 in the first shaft portion 44 are machined, and when the second engagement protrusions 60 and the spline hole portion 58 in the second shaft portion 46 are machined, there is an advantage in that for example, so-called one chuck machining that a machining member is machined without changing a chuck holding portion is possible or the reference in the direction of the axis C may be set near a machining portion. Thus, it is possible to easily perform accurate machining.

Next, another embodiment of the invention will be described. Note that, in the following description of the embodiment, like reference numerals denote similar components, and the overlap description of the similar components to those of the above described embodiment are omitted.

FIG. 14 is a cross-sectional view that shows a first shaft portion 80 of the vehicle drive shaft 10 according to another embodiment of the invention, and is a view corresponding to FIG. 6 in the above described embodiment. The first shaft portion 80 according to the present embodiment includes a two-stepped axial portion 84 and a tubular sleeve shaft portion 48. A small-diameter core shaft portion 50 and a proximal end 82 having a diameter larger than that of the core shaft portion 50 are formed at one end of the stepped axial portion 84. One end of the sleeve shaft portion 48 is fitted onto the outer peripheral surface of the proximal end 82 and is fixed to the stepped axial portion 84 by, for example, welding, or the like.

As compared with the first shaft portion 44 according to the above described embodiment, the first shaft portion 80 has substantially the same shape but differs in manufacturing process. That is, the first shaft portion 80 according to the present embodiment is manufactured as follows. First, one end of a tubular sleeve shaft portion 48 is fitted onto a stepped shaft-like member 84 of which one end is formed in a two-stepped axial shape by, for example, lathe, or the like, and is fixed, for example, by welding, or the like. Thus, an axial member is formed to include the hollow cylindrical sleeve shaft portion 48 and a columnar core shaft portion 50. The sleeve shaft portion 48 and the core shaft portion 50 have proximal ends that are fixed to each other around a middle portion in the direction of the axis C, and are formed longitudinally in the direction of the axis C on the distal end side with respect to the proximal ends and are provided coaxially with each other. Then, the axial member is machined as in the case of the above described embodiment to form the first engagement protrusions 52 and the spline shaft portion 54.

As described above, the vehicle drive shaft 10 according to the present embodiment includes the first shaft portion 80 that has a shape similar to that of the first shaft portion 44 according to the above described embodiment, and that includes the spline shaft portion 54 and the first engagement protrusions 52 that are located adjacent to each other at one end in the direction of the axis C. Therefore, similar advantageous effects to those of the above described embodiment may be obtained.

The embodiments of the invention are described in detail with reference to the accompanying drawings; however, the aspect of the invention is not limited to these embodiments. The aspect of the invention may be modified into the following alternative embodiments.

For example, in the above described embodiments, the vehicle drive shaft 10 is a front wheel drive shaft provided between a front wheel differential gear unit and a front wheel in an FF front wheel drive vehicle. Instead, for example, the vehicle drive shaft 10 may be a front wheel drive shaft used in an all-wheel drive vehicle, or a rear wheel drive shaft provided between a rear wheel differential gear unit and a rear wheel in, for example, an FR, MR or RR rear wheel drive vehicle or all-wheel drive vehicle.

In addition, in the above described embodiment, the first shaft portion 44 is provided at an inboard side, that is, at a side coupled to the differential gear unit 22, and the second shaft portion 46 is provided at an outboard side, that is, at a side coupled to the drive wheel 24. Instead, the first shaft portion 44 and the second shaft portion 46 may be interchanged in position.

In addition, in the above described embodiment, the first shaft portion 44 has the spline shaft portion 54, and the second shaft portion 46 has the spline hole portion 58. Instead, the first shaft portion 44 may have the spline hole portion 58, and the second shaft portion 46 may have the spline shaft portion 54.

In addition, in the above described embodiment, the spline shaft portion 54 and the spline hole portion 58 are formed of square spline. Instead, for example, the spline shaft portion 54 and the spline hole portion 58 may be formed of involute spline, or the like. In addition, the coupling structure is not limited to spline. Instead, the coupling structure may be, for example, formed of serration or a key and a key groove. In short, it is only necessary that the coupling structure couples the first shaft portion 44 to the second shaft portion 46 so that the first shaft portion 44 and the second shaft portion 46 are not rotatable around the axis C.

In addition, in the above described embodiment, the plurality of spline grooves of the spline shaft portion 54 and the plurality of first engagement protrusions 52 are formed so that the relative phases around the axis C coincide with each other; however, the relative phases around the axis C may not coincide with each other. Then, the six spline grooves of the spline shaft portion 54 and the six first engagement protrusions 52 both are provided at predetermined intervals around the axis C; however, the number of the spline grooves may be different from the number of the first engagement protrusions 52. In short, it is only necessary that in a state where the first shaft portion 44 is coupled to the second shaft portion 46, the first engagement protrusions 52 and the second engagement protrusions 60 are provided at predetermined gaps ψ in the circumferential direction.

In addition, in the above described embodiment, the closed-end annular groove 55 is provided between the sleeve shaft portion 48 and core shaft portion 50 of the first shaft portion 44, that is, between the inner peripheral surface of the sleeve shaft portion 48 and the outer peripheral surface of the core shaft portion 50; however, the closed-end annular groove 55 need not be provided. In short, it is only necessary that the distal end sides of the sleeve shaft portion 48 and core shaft portion 50 with respect to the proximal ends thereof are configured so as to be twistable relative to each other by a predetermined value.

In addition, in the above described embodiment, the first engagement protrusions 52 and spline shaft portion 54 of the first shaft portion 44 and the second engagement protrusions 60 and spline hole portion 58 of the second shaft portion are formed by so-called one chuck machining using a machining center; however, even when they are not machined by the one chuck machining, the first engagement protrusions 52 and the spline shaft portion 54 are located adjacent to each other in the direction of the axis C, and the second engagement protrusions 60 and the spline hole portion 58 are located adjacent to each other in the direction of the axis C. Thus, it is advantageously possible to accurately and easily machine the first engagement protrusions 52, spline shaft portion 54, second engagement protrusions 60 and spline hole portion 58. Then, the first engagement protrusions 52, spline shaft portion 54, second engagement protrusions 60 and spline hole portion 58 may be formed not only by the machining center but also, for example, by cutting using a milling machine, a slotting machine, a hobbing machine, a key seating cutter, a broaching machine, or the like. In addition, the first engagement protrusions 52, spline shaft portion 54, second engagement protrusions 60 and spline hole portion 58 may be formed not only by the above cutting but also by, for example, component rolling, or the like. Thus, various types of machining are possible.

The above described embodiments are only illustrative. Although not illustrated one by one other than the above embodiments, the aspect of the invention may be modified or improved into various forms on the basis of the knowledge of the person skilled in the art without departing from the scope of the invention.

1. A vehicle drive shaft that constitutes part of a power transmission path of a vehicle and that is provided to transmit power to a drive wheel, comprising:
a first shaft portion that has a core shaft portion and a sleeve shaft portion, which respectively have a first coupling portion and a first engagement portion at distal ends thereof, and which respectively have proximal ends integrally fixed to each other, and which extend longitudinally in the direction of the axis coaxially with each other; and
a second shaft portion that is provided coaxially with the first shaft portion and that has a second coupling portion and a second engagement portion, wherein the second coupling portion is fixed to the first coupling portion so that the second coupling portion is not rotatable about the axis relative to the first coupling portion, and the second engagement portion contacts the first engagement portion in a circumferential direction when a relative torsional angle between the first engagement portion and the second engagement portion is larger than or equal to a predetermined value, wherein
when the relative torsional angle between the first engagement portion and the second engagement portion is smaller than the predetermined value, a first torque is transmitted via the core shaft portion, and
when the relative torsional angle between the first engagement portion and the second engagement portion is larger than or equal to the predetermined value, a second torque that is larger than the first torque is transmitted via not only the core shaft portion but also the sleeve shaft portion.

2. The vehicle drive shaft according to claim 1, wherein
the first coupling portion is a spline shaft portion that is formed at the distal end of the core shaft portion,
the first engagement portion is a plurality of first engagement protrusions that protrude in the direction of the axis at a predetermined interval around the axis at the distal end of the sleeve shaft portion,
the second coupling portion is a spline hole portion that is bored at a center of one end surface of the second shaft portion, and
the second engagement portion is a plurality of second engagement protrusions that protrude from the one end surface of the second shaft portion in the direction of the axis at a predetermined interval around the axis so as to form a predetermined gap in the circumferential direction between the plurality of first engagement protrusions and the plurality of second engagement protrusions.

3. A vehicle comprising the vehicle drive shaft according to claim 1.

4. The vehicle according to claim 3, further comprising:
a torque converter that is connected to a power source for propelling the vehicle, that transmits power from the power source and that has a lock-up clutch; and
an automatic transmission that transmits the power from the torque converter to the drive shaft, wherein
the predetermined value of the relative torsional angle is a relative torsional angle between the first engagement portion and the second engagement portion around the axis of the drive shaft when the automatic transmission is set at a lowest speed gear, and when a maximum torque transmittable to the drive shaft at the time when the lock-up clutch is engaged is applied to the drive shaft.
